(19) United States
(12) Patent Application Publication
(10) Pub. No.: US 2016/0002487 A1
(43) Pub. Date: Jan. 7, 2016

(54) PROTECTIVE LACQUERS AND ADHESIVES BASED ON ACRYLATE

(71) Applicant: BAYER MATERIALSCIENCE AG, Leverkusen (DE)

(72) Inventors: Marc-Stephan Weiser, Leverkusen (DE); Ute FLEMM, Solingen (DE); Daniel HENTSCHEL, Köln (DE); Friedrich-Karl BRUDER, Krefeld (DE); Thomas RÖLLE, Leverkusen (DE); Horst BERNETH, Leverkusen (DE); Dennis HÖNEL, Zülpich-wichterich (DE); Thomas FÄCKE, Leverkusen (DE)

(21) Appl. No.: 14/769,938

(22) PCT Filed: Feb. 26, 2014
(86) PCT No.: PCT/EP2014/053723

§ 371 Date: Aug. 24, 2015

(30) Foreign Application Priority Data
Feb. 27, 2013 (EP) 13156949.3

(51) Int. Cl. C09D 133/14; B05D 3/06; B29C 63/00; C09D 133/08

(52) U.S. Cl. CPC C09D 133/14; C09D 133/08; B05D 3/067; B29C 63/0095; B29K 2049/00; B29L 2009/00

(57) ABSTRACT

The invention relates to a layered construction with a protective layer and a photoexposed photopolymer layer, the protective layer being obtainable by reaction of a mixture comprising or consisting of at least one radiation-curing resin I), a polyfunctional radiation-curing resin II) and a photoinitiator system III), the radiation-curing resin I) comprising ≦5 wt. % of compounds having a weight-average molecular weight <500 and ≧75 wt. % of compounds having a weight-average molecular weight >1000, the polyfunctional radiation-curing resin II) comprising or consisting of at least one acrylate having at least two radiation-curing groups, and the mixture comprising at least 55 wt. % of the radiation-curing resin I) and not more than 35 wt. % of the polyfunctional radiation-curing resin II). The invention further relates to a method for producing a layered construction of this kind, and also to its use.

The invention relates to a layered construction with a protective layer and a photoexposed photopolymer layer, the protective layer being obtainable by reaction of a mixture comprising or consisting of at least one radiation-curing resin I), a polyfunctional radiation-curing resin II) and a photoinitiator system III ), the radiation-curing resin I) comprising ≦5 wt. % of compounds having a weight-average molecular weight <500 and >75 wt.% of compounds having a weight-average molecular weight >1000, the polyfunctional radiation-curing resin II) comprising or consisting of at least one acrylate having at least two radiation-curing groups, and the mixture comprising at least 55 wt, % of the radiation-curing resin I) and not more than 35 wt. % of the polyfunctional radiation-curing resin II). The invention further relates to a method for producing a layered construction of this kind, and also to its use.

Photopolymer layers for producing holographic media are known in principle from WO 2011/054797 and WO 2011/067057. Advantages of these holographic media are their high diffractive light-bending efficiency and the fact that no extra processing steps are required after holographic exposure, such as chemical or thermal developing steps, for example. These photopolymer layers are preferably PU-based compositions.

DE 699 37 920 T2 describes how holographic photopolymer layers may vary their colour if substances undergo swelling into the photopolymer layer from adjacent layers such as layers of adhesive, or if substances bleed from the photopolymer layer into the adjacent layer. If one of the two phenomena occurs, there may be volume expansion or volume contraction in the photopolymer layer. This in turn leads to a long wave or short wave colour shift in the hologram. Especially in the case of multi-colour holograms, this results in unwanted visual colour changes.

In order to prevent volume changes and the associated colour changes, DE 699 37 920 T2 teaches the addition to the adjacent layers and/or to the photopolymer layer, beforehand, of sufficient amounts of the inwardly swelling or outwardly bleeding substances. This process, however, is costly and inconvenient, Furthermore, an adaptation must be undertaken, depending on the material that is to be used for the adjacent layer. Lastly, the substance added must also be selected such that it does not destroy the photopolymer layer.

The as yet unpublished patent application EP 12150275.1 describes how protective layers can be applied to a photoexposed photopolymer layer through suitable selection of the components. These protective layers can be produced by reacting at least one radiation-curing resin I), an isocyanate-functional resin H) and a photoinitiator system Ill). The protective layers described in EP 12150275.1 meet the requirements for a suitable protective layer, since after application they allow the provision of a layered construction with a protective layer and a photoexposed photopolymer layer, and this layered construction can be firmly joined to any of a very wide variety of adjacent layers, such as layers of adhesive, for example, without any volume changes in the photopolymer layer and any attendant colour changes in the hologram. The likewise as yet unpublished European patent application EP 12150277.7 discloses how the formulations stated in EP 12150275.1 may also be used for the direct adhesive bonding of photoexposed photopolymer layers.

The compositions disclosed in EP 12150275.1, however, are not satisfactory in every respect. As a result of the presence of an isocyanate-functional resin, they are comparatively unstable to moisture and are chemically reactive to isocyanate-reactive components such as OH and NH₂ groups, for example. Such groups, however, are frequently present in radiation-curing resins or other auxiliaries that are essential for an industrial formulation. As a result of this, the composition must always be provided anew prior to use, and this restricts its technical application, since it requires the presence at the application site not only of suitable mixing apparatus but also of suitable safety measures for the handling of isocyanate-functional components.

It was an object of the present invention, accordingly, to provide a layered construction with an improved protective layer which is easy to produce and which meets the requirements in relation both to compatibility and immutability of the photopolymer layer and to a sufficient protective function relative to adjacent layers, such as layers of adhesive, for example, that are later applied to this protective layer.

The object is achieved by means of a layered construction having a protective layer and a photoexposed photopolymer layer, the protective layer being obtainable by reaction of a mixture comprising or consisting of at least one radiation-curing resin I), a polyfunctional radiation-curing resin) II) and a photoinitiator system III), the radiation-curing resin I) comprising ≦5 wt. % of compounds having a weight-average molecular weight <500 and ≧75 wt. % of compounds having a weight-average molecular weight >1000, the polyfunctional radiation-curing resin II) comprising or consisting of at least one acrylate having at least two radiation-curing groups, and the mixture comprising at least 55 wt, % of the radiation-curing resin I) and not more than 35 wt. % of the polyfunctional radiation-curing resin II).

The invention is based on the finding, supported by experiments, that with the aforementioned protective layer it is possible, among other things, to stop the adverse effect of adhesives used to date on holograms generated in a photopolymer layer. This is especially so with regard to acrylate-based (pressure-sensitive) adhesives. It is thought that the protective layer functions as a diffusion barrier for low molecular mass substances from the adhesive into the holographic photopolymer layer.

The term “functional” refers to radiation-curing reactive groups, more particularly in the form of double bonds. “Polyfunctional” in this context means that the resin in question carries at least two of these radiation-curing reactive groups per molecule.

In accordance with the invention the mixture for producing the protective layer comprises at least one radiation-curing resin I), a polyfunctional radiation-curing resin II) and a photoinitiator system II). This means that in each case at least one or else, alternatively, two or more representatives—of the respective classes of substance is or are used. Together, the substances represented by radiation-curing resin I), polyfunctional radiation-curing resin II) and photoinitiator system III) together make up a maximum of 100 wt. %, or else less, if there are also further components present in the mixture,

Description of the Photopolymer Layer

Suitable photopolymer formulations for producing the photopolymer layer are likewise known to the skilled person and are described for example in WO-A 2011/054797 and WO 2011/067057. The photopolymer formulation for producing the photopolymer layer is preferably a formulation comprising a polyisocyanate component, an isocyanate-reactive component, at least one writing. monomer and at least one photoinitiator.

The polyisocyanate component a) comprises at least one organic compound which has at least two NCO groups. Polyisocyanate used may comprise all of the compounds known per se to the skilled person, or mixtures thereof. These compounds may have an aromatic, araliphatic, aliphatic or cycloaliphatic basis. In minor amounts, the polyisocyanate component a) may also comprise monoisocyanates, i.e. organic compounds having an NCO group, and/or polyisocyanates containing unsaturated groups.

Examples of suitable polyisocyanates are butylene diisocyanate, hexamethylene diisocyanate (HDI), 2,2,4-trimethylhexamethylene diisocyanate and its isomers (TMDI), isophorone diisocyanate (IPDI), 1,8-diisocyanato-4-(isoeyanatomethyl)octane, the isomeric bis(4,4′-isocyanatocyclohexyl)methanes and their mixtures with any desired isomer content, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-tolylene diisocyanate, 1,5-naphthylene diisocyanate, and/or 4,4′-diphenylmethane diisocyanate, triphenylmethane 4,4′,4″-triisocyanate or any desired mixtures of the aforementioned compounds.

Monomeric diisocyanates or triisocyanates having urethane, urea, carbodiitnide, acylurea, isocyanurate, allophanate, biuret, oxadiazinetrione, uretdione and/or iminooxadiazinedione structures may likewise be used.

Preferred polyisocyanates are those based on aliphatic and/or cycloaliphatic diisocyanates or triisocyanates. Particularly preferred are the polyisocyanates which are dimerized or oligomerized aliphatic and/or cycloaliphatic diisocyanates or triisocyanates. Especially preferred polyisocyanates are isocyanurates, uretdiones and/or iminooxadiazinediones based on HDI, TMDI, 1,8-diisocyanato-4-(isocyanatomethyl)octane or mixtures thereof.

The polyisocyanate component a) may also comprise or consist of NCO-functional prepolymers. The prepolymers may have urethane, allophanate, biuret and/or amide groups. Prepolymers of these kinds are obtainable for example by reaction with polyisocyanates a1) with isocyanate-reactive compounds a2).

Suitable polyisocyanates a1) are all known aliphatic, cycloaliphatic, aromatic or araliphatic diisocyanate and triisocyanate. Besides these it is also possible to use the known derivatives, of higher molecular mass, of monomeric diisocyanates and/or triisocyanates with urethane, urea, carbodiimide, acylurea, isocyanurate, allophanate, biuret, oxadiazinetrione, uretdione, iminooxadiazinedione structure, in each case individually or in any desired mixtures with one another.

Examples of suitable monomeric diisocyanates or triisocyanates which can be used as polyisocyanate a1) are butylene diisocyanate, hexamethylene di isocyanate, isophorone diisocyanate, trirnethylhexarnethylene diisocyanate (TMDI), 1,8-diisocyanato-4-(isocyanatomethypoctane, isocyanatomethyl-1,8-octane diisocyanate (TIN), 2,4- and/or 2,6-toluene diisocyanate.

As isocyanate-reactive compounds a2) it is possible with preference to use OH-functional compounds. These may more particularly be polyols, With especial preference it is possible as isocyanate-reactive compound a2) to use the component b) polyols described later on below.

It is likewise possible to use amines as isocyanate-reac . compounds a2). Examples of suitable amities are ethylenediamine, diethylenetriamine, triethylenetetramine, propylenediamine, diaminocyclohexane, diaminobenzene, diaminobisphenyl, difunctional polyamines such as, for example, the Jeffamine® products, amine-terminated polymers, more particularly having number-average molar masses of up to 10 000 g/mole. Mixtures of the aforementioned amines may likewise be used.

It is also preferable if the isocyanate-reactive compounds a2) have a number-average molar mass of ≧200 and ≦10 000 g/mole, more preferably ≧500 and ≦8500 g/mole and very preferably ≧1000 and ≦8200 g/mole.

The prepolymers of the polyisocyanate component a) may in particular have a residual free monomeric isocyanate content <1 wt. %, more preferably <0.5 wt. % and very preferably <0.2 wt. %.

The polyisocyanate component a) may also comprise mixtures of the aforementioned polyisocyanates and prepolymers.

It is optionally also possible for the polyisocyanate component a) to include, proportionally, polyisocyanates which have undergone partial reaction with isocyanate-reactive, ethylenically unsaturated compounds. As isocyanate-reactive, ethylenically unsaturated compounds here, preference is given to using α,β-unsaturated carboxylic acid derivatives such as actylates, methacrylates, nialeates, fumarates, maleimides, acrylamides, and also vinyl ethers, propenyl ethers, allyl ethers and compounds which comprise dicyclopentadienyi units, and which have at least one group that is reactive towards isocyanates. Particularly preferred are acrylates and methacrylates having at least one isocyanate-reactive group.

The proportion of the polyisocyanates in the polyisocyanate component a) which has undergone partial reaction with isocyanate-reactive, ethylenically unsaturated compounds may be 0 to 99 wt. %, preferably 0 to 50 wt. %, more preferably 0 to 25 wt. % and very preferably 0 to 15 wt. %.

It is optionally also possible for the polyisocyanate component a) to include, completely or proportionally, polyisocyanates which have undergone complete or partial reaction with blocking agents known from coating technology. Examples of blocking agents are alcohols, lactams, oximes, malonic esters, alkyl acetoacetates, triazoles, phenols, imidazoles, pyrazoles and also amities, such as, for example, butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-tert-butylbenzylamine, cyclopentanone carboxyethyl ester or mixtures thereof.

It is particularly preferable for the polyisocyanate component a) to comprise or consist of an aliphatic polyisocyanate or an aliphatic prepolymer, and preferably an aliphatic polyisocyanate or aliphatic prepolymer having primary NCO groups.

The isocyanate-reactive component b) comprises at least one organic compound which has at least two isocyanate-reactive groups (isocyanate-reactive compound). In the context of the present invention, hydroxyl, amino or thio groups are considered to be isocyanate-reactive groups.

As isocyanate-reactive component it is possible to use all systems which have on average at least 1.5 and preferably at least 2, more preferably 2 to 3, isocyanate-reactive groups.

Suitable isocyanate-reactive compounds are, for example, polyester, polyether, polycarbonate, poly(meth)acrylate and/or polyurethane polyols.

Particularly suitable polyester polyols are, for example, linear or branched polyester polyols, which are obtainable from aliphatic, cycloaliphatic or aromatic dicarboxylic acids and/or polycarhoxylie acids and/or their anhydrides, by reaction with polyhydric alcohols with an OH functionality ≧2.

The polyester polyols may also be based on natural raw materials such as castor oil. It is likewise possible for the polyester polyols to be based on homopolymers or copolymers of lactones. These may be obtained preferably by addition reaction of lactones and/or lactone mixtures such as butyrolactone, ε-caprolactone and/or methyl-ε-caprolactone with hydroxy-functional compounds such as polyhydric alcohols with an OH functionality ≧2, of the type specified above, for example.

The polyester polyols preferably have number-average molar masses of ≧400 and ≦4000 g/mole, more preferably of ≧500 and ≦2000 g/mole.

The OH functionality of the polyester polyols is preferably 1.5 to 3.5, more preferably 1.8 to 3.0.

Examples of dicarboxylic and/or polycarboxylic acids and/or anhydrides particularly suitable for preparing the polyesters are succinic, glutaric, adipic, pimefic, suberic, azeleic, sebacic, nonanedicarboxylic, decanedicarboxylic, terephthalic, isophthalic, o-phthalic, tetrahydrophthalic, hexahydrophthalic or trimellitic acid and also acid anhydrides such as o-phthalic anhydride, trimellitic anhydride or succinic anhydride, or mixtures thereof.

Examples of alcohols particularly suitable for preparing the polyesters are ethanediol, di-, tri- and tetraethylene glycol, 1,2-propanediol, di-, tri- and tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, 1,4-d ihydroxycyclohexane, 1,4-dinnethyloicyclohexane, octane-1,8-diol, decane-1,10-diol, dodecane-1,12-diol, trimethylolpropane, glycerol or mixtures thereof.

Suitable polycarbonate polyols are obtainable in a conventional way by reaction of organic carbonates or phosgene with diols or diol mixtures.

Examples of organic carbonates suitable for this reaction are dimethyl, diethyl and diphenyl carbonates.

Suitable polyhydric alcohols encompass the polyhydric alcohols with an OH functionality ≧2 referred to above as part of the discussion of the polyester polyols. With preference it is possible to use 1,4-butanediol, 1,6-hexanediol and/or 3-methylpentanediol.

Polyester polyols may also be converted into polycarbonate polyols. In the reaction of the stated alcohols to form polycarbonate polyols, particular preference is given to using dimethyl carbonate or diethyl carbonate.

The polycarbonate polyols preferably have number-average molar masses of ≧400 and ≦4000 g/mole, more preferably of ≧500 and ≦2000 g/mole.

The OH functionality of the polycarbonate polyols is preferably 1.8 to 3.2, more preferably 1.9 to 3.0.

Suitable polyether polyols are polyadducts, optionally of blockwise construction, of cyclic ethers with OH- or NH-functional starter molecules. Examples of suitable cyclic ethers are styrene oxides, ethylene oxide, propylene oxide, tetrahydrofuran, butylene oxide, epichlorohydrin, and also any desired mixtures thereof. As starter molecules it is possible to use the polyhydric alcohols with an OH functionality ≧2, identified above as part of the discussion of the polyester polyols, and also primary or secondary amines and amino alcohols.

Preferred polyether polyols are those of the aforementioned kind based exclusively on propylene oxide. Preference is likewise given to polyether polyols of the aforementioned kind which are random copolymers or block copolymers, based on propylene oxide with further 1-alkylene oxides, the 1-alykene oxide fraction being, in particular, not greater than 80 wt. %. Especially preferred are propylene oxide homopolymers and also random copolymers or block copolymers which have oxyethylene, oxypropylene and/or oxybutylene units, the fraction of the oxypropylene units, based on the total amount of all oxyethylene, oxypropylene and oxybutylene units, being more particularly ≧20 wt. %, preferably ≧45 wt. %. Oxypropylene and oxybutylene here encompass all linear and branched C₃ and C₄ isomers.

The polyether polyols preferably have number-average molar masses of ≧250 and ≦10 000 g/mole, more preferably of ≧500 and ≦8500 g/mole and very preferably of ≧600 and ≦4500 g/mole. Their OH functionality is preferably 1.5 to 4.0 and more preferably 1.8 to 3.1.

Further preferred polyether polyols consist of an isocyanate-reactive component comprising hydroxy-functional multiblock copolymers of type Y(Xᵢ—H)ₙ, with i=1 to 10 and n=2 to 8, the segments Xᵢ each being constructed from oxyalkylene units of the formula (1)

—CH₂—CH(R)—O— (I)

in which is an alkyl or an aryl radical which may also be substituted or be interrupted by heteroatoms (such as ether oxygens), or hydrogen, and V is the parent starter.

The radical R may preferably be a hydrogen, methyl, butyl, hexyl or octyl or an ether-group-containing alkyl radical. Preferred ether-group-containing alkyl radicals are based on oxyalkylene units.

Preferably n is an integer from 2 to 6, more preferably 2 or 3 and very preferably 2.

Likewise preferably i is an integer from 1 to 6, more preferably from 1 to 3 and very preferably is 1.

It is further preferred if the proportion of the segments Xᵢ, based on the total amount of the segments Xi and Y, is >50 wt. % and preferably ≧66 wt. %.

It is also preferred if the proportion of the segments Y, based on the total amount of the segments Xᵢ and Y, is <50 wt. % and preferably <34 wt. %.

The multiblock copolymers Y(Xᵢ-H)ₙ preferably have number-average molecular weights of >1200 g/mole, more preferably >1950 g./mole, but preferably <12 000 g/mole, more preferably <8000 g/mole.

The blocks Xᵢ may be homopolymers, consisting exclusively of the same repeating oxyalkylene units. They may also compose randomly of different oxyalkylene units or may in turn be constructed clockwise from different oxyalkylene units.

Preferably the segments X, are based exclusively on propylene oxide or on random or blockwise mixtures of propylene oxide with other 1-alkylene oxides, the fraction of other 1-alykene oxides being preferably not >80 wt. %.

Particularly preferred segments Xᵢ are propylene oxide homopolymers and also random copolymers or block copolymers which have oxyethylene and/or oxypropylene units. Very preferably in this case the proportion of the oxypropylene units, based on the total amount of all oxyethylene and oxypropylene units, is ≧20 wt. % and even more preferably ≧40 wt. %.

The blocks Xᵢ may be added on to an n-tuply hydroxy- or amino-functional starter Y(H)ₙ by ring-opening polymerization of the above-described alkylene oxides.

The starter Y(H)ₙ may consist of di- and/or higher poly-hydroxy-functional polymer structures based on cyclic ethers or of di- and/or higher poly-hydroxy-functional polycarbonate, polyester, poly(meth)acrylate, epoxy resin and/or polyurethane structural units or corresponding hybrids.

Examples of suitable starters Y(H)ₙ are the abovementioned polyester, polycarbonate and polyether polyols.

The polyester polyols preferably have number-average molar masses of 200 to 2000 g/mole, more preferably of 400 to 1400 g/mole.

The polycarbonate polyols preferably have number-average molar masses of 400 to 2000 g/mole, more preferably of 500 to 1400 g/mole and very preferably of 650 to 1000 g/mole.

The polyether polyols preferably have number-average molar masses of 200 to 2000 g/mole, more preferably of 400 to 1400 g/mole and very preferably of 650 to 1000 g/mole.

Particularly preferred starters Y(H)ₙ are, in particular, difunctional polymers of tetrahydrofuran, more particularly difunctional aliphatic polycarbonate polyols and polyester polyols, and also polymers of ε-caprolactone, in particular with number-average molar masses <3100 g/mole, preferably ≧500 g/mole and ≦2100 g/mole.

Other examples of suitable polyethers and processes for preparing them are described in EP 2 172 503 A1, whose relevant disclosure content is hereby incorporated by reference.

In the case of another preferred embodiment, provision is made for the writing monomer to comprise at least one mono- and/or one multi-functional writing monomer, the writing monomers in question being able more particularly to be mono- and multi-functional acrylate writing monomers. With particular preference the writing monomer may comprise at least one monofunctional and one multifunctional urethane(meth)acrylate.

The acrylate writing monomers may more particularly he compounds of the general formula (II)

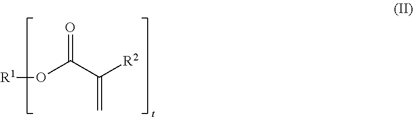

in which t≧1 and t≦4 and R¹ is a linear, branched, cyclic or heterocyclic unsubstituted or else optionally heteroatom-substituted organic radical and/or R² is hydrogen or a linear, branched, cyclic or heterocyclic unsubstituted or else optionally heteroatom-substituted organic radical. With particular preference R² is hydrogen or methyl and/or R¹ is a linear, branched, cyclic or heterocyclic unsubstituted or else optionally heteroatom-substituted organic radical.

It is similarly possible to add further unsaturated compounds such as α,β-unsaturated carboxylic acid derivatives such as acrylates, methacrylates, maleates, furnarates, maleimides, acrylamides, also vinyl ethers, propenyl ethers, allyl ethers and dicycloperitadierryl unit-containing compounds and also olefinically unsaturated compounds such as, for example, styrene, tx-rnethylstyrene, vinyltoluene, olefins, for example 1-octene and/or 1-decene, vinyl esters, (meth)acrylonitrile, (meth)acrylamide, methacrylic acid, acrylic acid. Preference, however, is given to acrylates and methacrylates.

In general, esters of acrylic acid and methacrylic acid are designated as acrylates and methacrylates, respectively. Examples of acrylates and methacrylates which can be used are methyl acrylate, methyl methacrylate, ethyl acrylate, ethyl methacrylate, ethoxyethyl acrylate, ethoxyethyl methacrylate, n-butyl acrylate, n-butyl methacrylate, tert-butyl acrylate, tert-butyl methacrylate, hexyl acrylate, hexyl methacrylate, 2-ethythexyl acrylate, 2-ethylhexyl methacrylate, hutoxyethyl acrylate, hutoxyethyl methacrylate, lauryl acrylate, lauryl methacrylate, isobomyl acrylate, isobornyl methacrylate, phenyl acrylate, phenyl methacrylate, p-chlorophenyl acrylate, p-chlorophenyl methacrylate, p-bromophenyl acrylate, p-bromophertyl methacrylate, 2,4,6-trichloropheityl acrylate, 2,4,6-trichlorophenyl methacrylate, 2,4,6-tribromophertyl acrylate, 2,4,6-tribromophertyl methacrylate, pentachiorophenyl acrylate, pentachlorophenyl methacrylate, pentabromophenyl acrylate, pentabrornophenyl methacrylate, pentabrotnobenzyl acrylate, pentabromobenzyi methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaplithyl)-2-butyl methacrylate, propane-2,2-diylbis[(2,6-dibromo-4,1-phenylene)oxy(2-{[3,3,3-tris(4-chlorophenyl)propanoyl]oxyl}propane-3,1-diyl)oxyethane-2, ]diacrylate, bisphenol A diacrylate, bisphenol A dimethaerylate, tetrabromobisphenol A diacrylate, tetrabromobisphenol A dimethacrylate and the ethoxylated analogue compounds thereof, N-carbazolyl acrylates, to mention only a selection of acrylates and methacrylates which may be used.

As acrylates, urethane acrylates can of course also be used. Urethane acrylates are understood as meaning compounds having at least one acrylic ester group which additionally have at least one urethane bond. It is known that such compounds can be obtained by reacting a hydroxy-functional acrylic ester with an isocyanate-functional compound.

Examples of isocyanate-functional compounds which can be used for this purpose are aromatic, araliphatic, aliphatic and cycloaliphatic di-, tri- or polyisocyanates. It is also possible to use mixtures of such di-, tri- or polyisocyanates. Examples of suitable di-, tri- or polyisocyanates are butylene diisocyanate, hexamethylerie diisocyanate (HDI), isophorone diisocyanate (IPDI), 1,8-diisoeyanato-4-(isocyanatomethyl)octane, 2,2,4- and/or 2,4,4-trimethylhexamethylene diisocyanate, the isomeric bis(4,4′-isocyanatocyclohexypiriethanes and mixtures thereof having any desired isomer content, isocyanatornethyl-1,8-octane diisocyanate, 1,4-cyclohexylene diisocyanate, the isomeric cyclohexanedimethylene diisocyanates, 1,4-phenyiene diisocyanate, 2,4- and/or 2,6-tolyiene diisocyanate, 1,5-naphthylene diisocyanate, 2,4′- or 4,4′-diphenylmethane diisocyanate. 1,5-maphthylene diisocyanate, m-methylthiophertyl isocyanate, triphenylmethane 4,4′, 4″-triisocyanate and tris(p-isocyanatophenyl) thiophosphate or derivatives thereof having a urethane, urea, carbodiirnide, acylurea, isocyanurate, allophariate, biuret, oxadiazinetrione, uretdione or iininooxadiazinedione structure and mixtures thereof. Aromatic or araliphatic di-, tri- or polyisocyanates are preferred in this case.

Suitable hydroxy-functional acrylates or methacrylates for the preparation of urethane acrylates are compounds for example such as 2-hydroxyethyl(meth)acrylate, polyethylene oxide mono(meth)acrylates, polypropylene oxide mono(meth)acrylates, polyalkylene oxide mono(meth)acrylates, poly(ε-caprolactone) mono(meth)acrylates, such as, for example, Tone® M100 (Dow, Schwalbach, Germany), 2-hydroxypropyl(meth)acrylate, 4-hydroxybutyl(meth)acrylate, 3-hydroxy-2,2-dimethylpropyl(meth)acrylate, hydroxypropyl(meth)acrylate, 2-hydroxy-3-phenoxypropyl acrylate, the hydroxyfunctional mono-, di- or tetraacrylates of polyhydric alcohols, such as trimethylolpropane, glycerol, pentaerythritol, dipentaerythritol, ethoxylated, propoxylated or alkoxylated trimethylolpropane, glycerol, pentaerythritol, dipentaerythritol or industrial mixtures thereof. 2-Hydroxyethyl acrylate, hydroxypropyl acrylate, 4-hydroxybutyl acrylate and poly(ε-caprolactone) mono(meth)acrylates are preferred.

In addition, isocyanate-reactive oligomeric or polymeric unsaturated compounds containing acrylate and/or methacrylate groups, alone or in combination with the a.bovementioned monomeric compounds, are suitable, The epoxy (meth)acrylates known per se containing hydroxyl groups and having OH contents of 20 to 300 mg KOH/g or polyurethane(meth)acrylates containing hydroxyl groups and having OH contents of 20 to 300 mg KOH/g or acrylated polyacrylates having OH contents of 20 to 300 mg KOH/g and mixtures thereof with one another and mixtures with unsaturated polyesters containing hydroxyl groups and mixtures with polyester (meth)acrylates or mixtures of unsaturated polyesters containing hydroxyl groups with polyester (meth)acrylates can likewise be used.

Preference is given particularly to urethane acrylates obtainable from the reaction of tris(p-isocyanatophenyl)thiophosphate and m-methylthiophenyl isocyanate with alcohol-functional acrylates such as hydroxyethyl(meth)acrylate, hydroxypropyl(meth)acrylate and hydroxybutyl(meth)acrylate.

Particularly preferred is a combination of components a) and b) in the production of matrix polymers consisting of adducts of butyrolactone, e-caprolactone and/or methyl-ε-caprolactone onto polyether polyols with a functionality of 1.8 to 3.1, having number-average molar masses of 200 to 4000 g/mol, in conjunction with isocyanurates, uretdiones, iminooxadiazinediones and/or other oligomers based on HDI. Especially preferred are adducts of e-caprolactone onto poly(tetrahydrofurans) having a functionality of 1.9 to 2.2 and number-average molar masses of 500 to 2000 g/mol (more particularly 600 to 1400 g/mol), whose number-average overall molar mass is from 800 to 4500 g/mole, more particularly from 1000 to 3000 g/mole, in conjunction with oligomers, isocyanurates and/or iminooxadiazinediones based on HDI.

In another preferred embodiment, it is provided that the photopolymer formulation further comprises urethanes as additives, it being possible for the urethanes more particularly to be substituted by at least one fluorine atom.

The urethanes preferably may have the general formula (III)

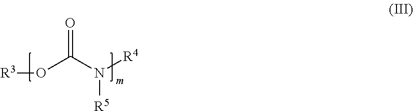

in which m≧1 and m≦8 and R³ is a linear, branched, cyclic or heterocyclic, organic radical which is unsubstituted or else optionally substituted by heteroatoms, and/or R⁴, R⁵ independently of one another are hydrogen, preferably at least one of the radicals R³, R⁴, R⁵ being substituted by at least one fluorine atom, and more preferably R³ being an organic radical having at least one fluorine atom. With particular preference R⁵ is a linear, branched, cyclic or heterocyclic organic radical which is unsubstituted or else optionally also substituted by heteroatoms such as fluorine, for example.

The photoinitiators employed are typically compounds which are activatable by actinic radiation and capable of inducing a polymerization of the corresponding groups.

Suitable photoinitiators are typically compounds which are activatable by actinic radiation and capable of inducing a polymerization of the corresponding groups. Among the photoinitiators there is a distinction to be made between unimolecular initiators (type I) and bimolecular initiators (type II). They are further distinguished according to their chemical character into photoinitiators for radical, anionic, cationic or mixed type of polymerization; there is a broad prior art relating to this.

Type I photoinitiators (Norrish type I) for radical photopolymerization form free radicals on irradiation by unimolecular bond cleavage.

Examples of type I photoinitiators are triazines, for example tris(trichloromethyl)triazine, oximes, benzoin ethers, benzil ketals, alpha-alpha-dialkoxyacetophenone, phenylglyoxylic esters, bisimidazoles, aroylphosphine oxides, e.g. 2,4,6-trimethylberizoyldiphenylphosphine oxide, suiphonium and iodonium salts.

Type II photoinitiators (Norrish type II) for radical polymerization undergo a bimolecular reaction on irradiation wherein the photoinitiator reacts in the excited state with a second molecule, the coinitiator, and forms the polymerization-inducing radicals by electron or proton transfer or direct hydrogen abstraction.

Examples of type II photoinitiators are quinones, for example camphorquinone, aromatic keto compounds, for example benzophenones combined with tertiary amines, alkylbenzophenones, halogenated benzophenones, 4,4′-bis(dimethylamino)benzophenorie (Michler's ketone), anthrone, methyl p-(dimethylamino)benzoate, thioxanthone, ketocoumarins, alpha-aminoalkylphenone, alpha-hydroxyalkylphenone and cationic dyes, for example methylene blue, combined with tertiary amines.

Type I and type II photoinitiators are used for the UV and short-wave visible region, while predominantly type II photoinitiators are used for the comparatively long-wave visible light region.

The photoinitiator systems described in EP 0 223 587 A. consisting of a mixture of an ammonium alkylarylborate and one or more dyes, are also useful as type II photoinitiator for radical polymerization. Examples of suitable ammonium alkylaiylborate are tetrabutylammonium triphenylhexylborate, tetrabutylammonium triphenylbutylborate, tetrabutylammonium tri-naphthylhexylborate, tetrabutylammonium tris(4-tert-butyl)phenylbutylborate, tetrabutyl-ammonium tris(3-fluorophenyl)hexylborate, tetramethylammonium triphenylbenzylborate, tetra(n-hexyl)ammonium (sec-butyptriphenylborate, 1-methyl-3-octylimidazolium dipentyldiphenylborate and tetrabutylammonium tris(3-chloro-4-methylphenyl)hexylborate (Cunningham et al., RadTech'98 North America UV/EB Conference Proceedings, Chicago, Apr. 19-22, 1998).

The photoinitiators used for anionic polymerization are generally type I systems and derive from transition metal complexes of the first row. Examples which may be mentioned here are chromium salts, for example trans-Cr(NH₃)₂(NCS)₄⁻ (Kutal et al, Macromolecules 1991, 24, 6872) or ferrocenyl compounds (Yamaguchi et al. Macromolecules 2000, 33, 1152).

A further option for anionic polymerization is to use dyes, such as crystal violet leuconitrile or malachite green leuconitrile, which are capable of polymerizing cyanoacrylates through photolytic decomposition (Neckers et al. Macromolecules 2000, 33, 7761). The chromophore is incorporated here into the resulting polymers, making them intrinsically coloured.

Photoinitiators useful for cationic polymerization consist essentially of three classes: aryldiazoniuin salts, onium salts (here specifically: iodonium, sulphonium and selenonium salts) and also organometallic compounds. Phenyldiazonium salts are capable on irradiation of producing, not only in the presence but also in the absence of a hydrogen donor, a cation which initiates the polymerization. The efficiency of the overall system is determined by the nature of the counterion used to the diazonium compound. Preference is given here to the little-reactive but fairly costly SbF₆⁻, AsF₆⁻ or PF₆⁻. These compounds are generally less suitable for use in coating thin films, since the nitrogen released following exposure reduces surface quality (pinholes) (Li et al., Polymeric Materials Science and Engineering, 2001, 84, 139).

Onium salts, specifically sulphoniutn and iodonium salts, are very widely used and also commercially available in a wide variety of forms. The photochemistry of these compounds has been the subject of sustained investigation. todonium salts on excitation initially disintegrate homolyticatiy and thereby produce one radical and one radical cation which transitions first by hydrogen abstraction into a cation which finally releases a proton and thereby initiates cationic polymerization (Dektar et al. J. Org. Chem. 1990, 55, 639; J. Org. Chem., 1991, 56. 1838). This mechanism makes it possible for iodonium salts to likewise be used for radical photopolymerization. The choice of counterion is again very important here. Preference is likewise given to using SbF₆⁻, AsF₆⁻ or PF₆⁻. This structural class is in other respects fairly free as regards the choice of substitution of the aromatic, which is essentially determined by the availability of suitable synthous. Sulphonium salts are compounds that decompose by the Norrish type II mechanism (Criveilo et al., Macromolecules, 2000, 33, 825). The choice of counterion is also critically important in sulphonium salts, and is substantially reflected in the curing rate of the polymers. The best results are generally achieved with SbF₆³¹ salts.

Since the intrinsic absorption of iodonium and sulphonium salts is at <300 nm, these compounds should be appropriately sensitized for photopolymerization with near UV or short-wave visible light. This is accomplished by using aromatics that absorb at longer wavelengths, for example anthracene and derivatives (Gu et al. Am. Chem. Soc. Polymer Preprints, 2000, 41 (2), 1266) or phenothiazine and/or derivatives thereof (Hua et al, Macromolecules 2001, 34, 2488-2494).

It can be advantageous to use mixtures of these sensitizers or else photoinitiators. Depending on the radiation source used, photoinitiator type and concentration has to be adapted in a manner known to a person skilled in the art. Further particulars are described for example in P. K. T. Miring (Ed.), Chemistry & Technology of UV & EB Formulations For Coatings, Inks & Paints, Vol. 3, 1991, SETA Technology, London, pp. 61-328.

Preferred photoinitiators are mixtures of tetrabutylammonium tetrahexylborate, tetrabutylammonium triphenylhexylborate, tetrabutylammonium triphenylbutylborate, tetrabutylammonium tris(3-fluorophenyl)hexylborate ([191726-69-9], CGI 7460, product from BASF SE, Basel, Switzerland) and tetrabutylammonium tris-(3-chloro-4-methylphenyl)hexylborate ([1147315-11-4], CGI 909, product from BASF SE, Basel, Switzerland) with dyes of the formula (I).

Examples of cationic dyes are Astrazon Orange Ci, Basic Blue 3, Basic Orange 22, Basic Red 13, Basic Violet 7, Methylene Blue, New Methylene Blue, Azure A, Pyrillium I, Safranin O, cyanine, gallocyanine, brilliant green, crystal violet, ethyl violet and thionine.

It is particularly preferable for the photopolymer formulation of the invention to contain a cationic dye of formula F⁺An⁻.

Cationic dyes of formula F⁺ are preferably cationic dyes of the following classes: acridine dyes, xanthene dyes, thioxanthene dyes, phenazine dyes, phenoxazine dyes, phenothiazine dyes, tri(het)arylmethane dyes—especially diatnino—and triamino(het)arylmethane dyes, mono-, di- and trimethinecyanine dyes, hemicyanine dyes, externally cationic merocyanine dyes, externally cationic neutrocyanine dyes, nullmethine dyes—especially naphtholactain dyes, streptocyanine dyes. Such dyes are described for example in H. Berneth in Ullmann's Encyclopedia of Industrial Chemistry, Azine Dyes, Wiley-VCH Verlag, 2008, H. Berneth in Ullmann's Encyclopedia of Industrial Chemistry, Methine Dyes and Pigments, Wiley-VCH Verlag, 2008, T. Gessner, U. Mayer in Ullmann's Encyclopedia of Industrial Chemistry, Triarylmethane and Diatylmethane Dyes, Wiley-VCH Verlag, 2000.

An⁻ is to be understood as referring to an anion. Preferred anions An⁻ are especially C₈- to C₂₅-alkanesulphonate, preferably C₁₃- to C₂₅-alkanesulphonate, C₃- to C₁₈-perfluoroalkanesulphonate, C₄- to C₁₈-perfinoroalkanesulphonate bearing at least 3 hydrogen atoms in the alkyl chain, C₉- to C₂₅-alkanoate, C₉- to C₂₅-alkenoate, C₈- to C₂₅-alkyl sulphate, preferably C₁₃- to C₂₅-alkyl sulphate, C₈- to C₂₅-alkenyl sulphate, preferably C₁₃- to C₂₅-alkenyl sulphate, C₃- to C₁₈-perfluoroalkyl sulphate. C₄- to C₁₈-perfluoroalkyl sulphate bearing at least 3 hydrogen atoms in the alkyl chain, polyether sulphates based on at least 4 equivalents of ethylene oxide and/or 4 equivalents of propylene oxide, bis-C₄- to C₂₅-alkyl sulphosuccinate, C₅- to C₇-cycloalkyl sulphosuccinate, C₃- to C₈-alkenyl sulphosuccinate, C₇- to C₁₁-aralkyl sulphosuccinate, bis-C₂- to C₁₀-alkyl sulphosuccinate substituted by at least 8 fluorine atoms, C₈- to C₂₅-alkyl sulphoacetates, benzenesulphonate substituted by at least one moiety from the group halogen, C₄- to C₂₅-alkyl, perfluoro-C₁- to C₈-alkyl and/or C₁- to C₁₂-alkoxycarbonyl, optionally nitro-, cyano-, hydroxyl-, C₁- to C₂₅-alkyl-, C₁- to C₁₂-alkoxy-, amino-, C₁- to C₁₂-alkoxycarbonyl- or chlorine-substituted naphthalene- or biphenylsulphonate, optionally nitro-, cyano-, hydroxyl-, C₁- to C₂₅-alkyl-, C₁- to C₂-alkoxy-, C₁- to C₁₂-alkoxycarbonyl- or chlorine-substituted benzene-, naphthalene- or biphenyldisulphonate, dinitro-, C₆- to C₂₅-alkyl-, C₄- to C₁₂-alkoxycarbonyl-, benzoyl-, clilorobenzoyl- or toluoyl-substituted benzoate, the anion of naphthalenedicarboxylic acid, diphenyl ether disulphonate, sulphonated or sulphated, optionally mono- or polyunsaturated C₈- to C₂₅-fatty acid esters of aliphatic C₁to C₈-alcohols or glycerol, bis(sulpho-C₂- to C₆-alkyl) C₃ to C₁₂ alkanedicarboxylic acid esters, bis(sulpho-C₂ to C₆-alkyl) itaconic acid esters, (sulpho-C₂- to C₆-alkyl) C₆- to C₁₈-alkanecarboxylic acid esters, (sulpho-C₂- to C₆-alkyl) acrylic or methacrylic acid esters, triscatechol phosphate optionally substituted by up to 12 halogen moieties, an anion from the group tetraphenylborate, cyanotriphenyiborate, tetraphenoxyborate, C₄- to C₁₂-alkyltriphenylborate whose phenyl or phenoxy moieties may be halogen-, C₁- C₄alkyl- and/or C₁- to C₄alkoxy-substituted, C₄- to C₁₂-alkyltrinaphthylborate, tetra-C₁- to C₂₀alkoxyborate, 7,8- or 7,9-dicarbanidoundecaborate(1−) or (2−), which are optionally substituted by one or two C₁to C₁₂-alkyl or phenyl groups on the B and/or C atoms, dodecahydrod icarbadodecaborate(2−) or 13-Cᵣ to C₁₂-alkyl-C-phenyl dodecahydrodicarbadodecaborate(1−), where An⁻ in polyvalent anions such as naphthalenedisulphonate represents one equivalent of this anion, and where the alkane and alkyl groups may be branched and/or may be halogen-, cyano-, methoxy-, ethoxy-, methoxycarbonyl- or ethoxycarbonyl-substituted.

Particularly preferred anions are sec-C₁₁- to C₁₈-alkanesulphonate, (C₁₃- to C₂₅-alkyl sulphate, branched C₈- C₂₅-alkyl sulphate, optionally branched bis-C₆- to C₂₅-alkyl sulphosuccinate, sec- or tert-C₄- to C₂₅-alkylbenzenesulphonate, sulphonated or sulphated, optionally monounsaturated or polyunsaturated C₈- to C₂₅-fatty acid esters of aliphatic C₁to C₈-alcohols or glycerol, bis(sulpho-C₂- to C₆-alkyl) C₃- to C₁₂-alkanedicarboxylic acid esters, (sulpho-C₂- to C₆-alkyl) C₆- to C₁₈-alkanecarboxylic acid esters, triscatechol phosphate substituted by up to 12 halogen moieties, cyanotriphenylborate, tetraphenoxyborate, butyltriplienylborate.

It is preferable for the anion An⁻ of the dye to have an AC log P in the range of 1-30, more preferably in the range of 1-12 and even more preferably in the range of 1-6.5. The AC log P is computed as described in J. Comput. Mol. Des. 2005, 19, 453; Virtual Computational Chemistry Laboratory, http://www.vcclab.org

It is especially preferable for the photoinitiator to comprise a combination of dyes whose absorption spectra cover the spectral region from 400 to 800 nm, partly at least, with at least one coinitiator tuned to the dyes,

It is preferable for the photopolymer formulation to comprise at least one photoinitiator which is suitable for a laser light colour selected from blue, green and red.

It is further preferable for the photopolymer formulation to comprise one suitable photoinitiator each for at least two laser light colours selected from blue, green and red.

It is especially preferable, lastly, for the photopolyiner formulation to comprise one suitable photoinitiator each for each of the laser colours blue, green and red.

The layer P may preferably have a thickness of from 5 μm to 100 μm, more preferably from 5 μm to 30 μm, very preferably from 10 μm to 25 μm.

In preferred embodiments of the invention, the layer P may have been applied to a substrate layer S. Preferred materials or assemblies of materials forming the substrate (S) are based on transparent films based on polycarbonate (PC), polyethylene terephthalate (PET), polybutylene terephthalate (PBT), polyethylene, polypropylene, cellulose acetates, cellulose hydrate, cellulose nitrate, cycloolefin polymers, polystyrene, polyepoxides, polysulphone, cellulose triacetate (CTA), polyamide, polymethyl methacrylate, polyvinyl chloride, polyvinyl butyral or polydicyclopentadiene or mixtures thereof. Preferably they are based on films which have high optical quality and exhibit a good refractive index match with the photopolymer formulation used. More preferably they are based on PC, PET and CTA.

In principle it is also possible to use assemblies of materials such as film laminates or coextrudates employed for the substrate (S). Preferred assemblies of materials are duplex and triplex films constructed according to one of the schemes A/B, A/B/A or A/B/C. Particularly preferred are PC/PET, PET/PC/PET and PC/TPU (TPU=thermoplastic polyurethane).

The thickness of the layer S may be 15 to 375 μm, preferably 23 μm to 175 μm, more preferably 36 μm to 125 μm.

A volume hologram is photoexposed into the layer P. This hologram may be a reflection, transmission or edgelit hologram. Incorporation by photoexposure is performed using a monochromatic laser, where an interference field is generated by means of a beam splitter and the widening of the laser beam. This laser may generate different colours (frequencies of light); with preference a blue, red, green or yellow emission wavelength may be used. It is likewise possible to use different-coloured lasers simultaneously and in succession. In this way, therefore, it is possible to generate two or multi-coloured reflection holograms.

In the layer P there may be one or more holograms incorporated by photoexposure at the same location or alongside one another. By photoexposure at the same location it is possible to incorporate different image contents. It is likewise possible as well to incorporate, by photoexposure, different aspects of an object with slightly varying reconstruction angles, thus producing stereograms. Likewise possible is the incorporation, by photoexposure, of hidden holograms and microtexts. In the case of transmission holograms it is equally possible to incorporate, by photoexpostire, a plurality of light-guiding functions, and/or light-guiding functions for different spectral ranges.

Description of the Radiation-Curing Resin I)

The radiation-curing resin I) preferably comprises at least one polyester-, polyether-, polycarbonate- and/or polyurethane-containing binder having radiation-curing groups, more particularly radically polymerizable groups, the radically polynierizable groups being preferably acryloyl, methacrytoyl, allyl, vinyl, maleyl and/or fumaryl groups, more preferably acryloyl and/or methacryloyi groups and very preferably acryloyl groups. (Meth)acryloyl-containing binders are prepared generally by It) esterifying (meth)acrylic acid with polyols (see, for example, DE 000019834360A1, EP 000000900778B1) or with poly-oxalkylated polyols in accordance with DE 10 2007 037140 A1. According to the chemical groups present in the polyols, the products are referred to as polyester acrylates, polyether acrylates or polycarbonate acrylates. Where there are two or more types of group present, terms such as polyether/ester acrylates, for example, are also used.

It is likewise possible as well for (meth)acryloyl-containing binders to be precrosslinked with di- or polyisocyanates to give higher molecular mass resins, as a result of which urethane groups are introduced additionally. Such resins are called urethane acrylates. If aliphatic isocyanates are used, the products are also called aliphatic urethane acrylates. If aromatic isocyanates are used, then these products are also called aromatic urethane acrylates. Urethane acrylates are also taken to include adducts of di- and polyisocyanates with hydroxyl group functional acrylic esters, such as, for example, hydroxyethyl, hydroxypropyl and hydroxybiql acrylates, as described for example in DE 19944156 A1 and DE 10143630 A1.

Advantageous low-viscosity urethane acrylates which additionally contain allophanate groups may also be used. They are provided with specific catalysis from isocyanates and from urethane acrylates prepared as intermediates, in accordance with, among others, DE 102004048873 A1 and DE 102009008569 A1, and are likewise highly suitable.

Binders which can further be used are epoxy acrylates, which may be prepared by reaction of epoxy' resins with acrylic acid. Epoxy resins are reaction products of low molecular mass diepoxides, of the kind obtainable, for instance, from bisphenol-A and epichlorohydrin in different blending proportions.

Other epoxy acrylates, based on different aliphatic or aromatic alcohols/phenols with epichlorohydrin, and subsequent reaction with acrylic acid, can likewise be used.

The radiation-curing resin I) preferably comprises at least one compound from the group of polyether acrylates, polyester acrylates, aliphatic urethane acrylates, aromatic urethane acrylates and epoxy acrylates, and preferably at least one aliphatic urethane acrylate and/or at least one aromatic urethane acrylate.

In another preferred embodiment of the invention the radiation-curing resin I) comprises ≦4 wt. % of compounds having a weight-average molecular weight <500 and ≧77 wt. % of compounds having a weight-average molecular weight >1000, and preferably ≦3.5 wt. % of compounds having a weight-average molecular weight <500 and >79 wt.% of compounds having a weight-average molecular weight >1000. Blends of different radiation-curing resins I) may likewise he used as well. These mixtures are then subject by analogy to the suitable weight-average molecular weight proportions stated above, which relate to the averaged weight-average molecular weight proportions of these mixtures.

In the mixture for producing the protective layer, one or more radiation-curing resins I) are used to an extent of at least 55 wt. %, preferably at least 60 wt. % more preferably at least 75 wt. %, with particular preference at least 80 wt. %.

Description of the Polyfunctional Radiation-Curing Resin II)

The polyfunctional radiation-curing resin II) comprises or consists preferably of one or more radiation-curing compounds having at least in each case two radiation-curing groups, more particularly radically polymerizable groups, per molecule, the radically polymerizable groups being preferably acryloyl, methacryloyl, allyl, vinyl, maleyl and/or fumaryl groups, more preferably acryloyl and/or methacryloyl groups and very preferably acryloyl groups.

The compounds used in the polyfunctional radiation-curing resin II) preferably comprise at least three and/or at least four radiation-curing groups, more particularly radically polymerizable groups, per molecule. With particular preference the compounds used in the polyfunctional radiation-curing resin II) contain precisely three and/or precisely four radiation-curing groups, more particularly radically polymerizable groups, per molecule.

Preference is given to using polyfunctional acrylates and/or methacrylates, more preferably at least difunctional constituents, with more particular preference at least trifunctional constituents and very preferably tri- and/or tetrafunctional constituents, with “functional” referring to the number of respectively radiation-curing reactive groups, preferably in the form of double bonds.

Examples of particularly suitable polyfunctional acrylates include tris[2-(acryloyloxy)ethyl]isocyanurate, trimethylolpropane triacrylate, di(trimethylol)tetraacry,late, pentaerythritol triacrylates, pentaerythritol tetraacrylates, glycerol propoxylate triacrylate with 0.3-9 propoxy units, glycerol ethoxylate triacrylate with 0.3-9 ethoxy units, and dipentaerythritol hexaacrylate.

In addition, preparations of different polyfunctional radiation-curing resins II) may likewise be used.

In the mixture for producing the protective layer there is at most 35%, more advantageously 3 wt. % to 33 wt, %, of one or more polyfunctional radiation-curing resins II) used, preferably 5 wt. % to 15 wt. %,

Description of the Photoinitiator System III)

The photoinitiator system III) comprises initiators which are able to induce radical polymerization on exposure to high-energy radiation such as UV light, for example. Such photoinitiators are described in, for example, P. K. T. Oldring (Ed.), Chemistry & Technology of UV & EB Formulations For Coatings, Inks & Paints, Vol. 3, 1991, SITA Technology. London, pp. 61-325. The photoinitiator system III) may preferably comprise at least one compound from the group of 2-hydroxyphenyl ketones, especially 1-hydroxycyclohexyl phenyl ketone, benzil ketals, especially benzil dimethyl ketal, acylphospine oxides, more particularly bis(2,4,6-trimethylbenzoyl)phenylphosphine oxide, diacylphospine oxides, benzophenone and derivatives thereof. They can be used alone or in a mixture, optionally also together with further accelerators or coinitiators, as addition, calculated on the basis of the solids content of the coating system, in amounts of 0.1 to 10 wt. %, preferably 0.2 to 7 wt. %, more preferably 0.5 to 5 wt. %.

Description of the Radiation-Curing Resin IV)

The formulation may optionally comprise ≦10 wt. % of another low molecular mass, radiation-curing resin IV).

The radiation-curing resin IV) is preferably selected from one or more radiation-curing compounds having radically polymerizable groups, the radically polymerizable groups being preferably acryloyl, methacryloyl, allyl, vinyl, maleyl and/or fumaryl groups, more preferably acryloyl and/or methacryloyl groups.

Termed acrylates and methacrylates are, generally, esters of acrylic acid and, respectively, methacrylic acid. Examples of acrylates and methacrylates which can be used are methyl acrylate, methyl methacrylate, ethyl acrylate, ethyl methacrylate, ethoxyethyl acrylate, ethoxyethyl methacrylate, n-butyl acrylate, n-butyl methacrylate, tert-butyl acrylate, tert-butyl methacrylate, hexyl acrylate, hexyl methacrylate, 2-ethylhexyl acrylate, 2-ethylhexyl methacrylate, butoxyethyl acrylate, butoxyethyl methacrylate, lauryl acrylate, lauryl methacrylate, isobornyl acrylate, isobornyl methacrylate, tetrahydrofurfuryl acrylate, phenyl acrylate, phenyl methacrylate, p-chlorophenyl acrylate, p-chlorophenyl methacrylate, p-bromoplienyl acrylate, p-bromophenyl methacrylate, 2,4,6-triehlorophenyl acrylate, 2,4,6-trichlorophenyl methacrylate, 2,4,6-tribromophenyl acrylate, 2,4,6-tribromophenyl methacrylate, pentachlorophenyl acrylate, pentachlorophenyl methacrylate, pentabromophenyl acrylate, pentabromophenyl methacrylate, pentabromobenzyl acrylate, pentabromobenzyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2naphthyl methacrylate, 1,4-bis(2-thionaphthyl)-2-butyl acrylate, 1,4-bis(2-thionaphthyl)-2-butyl methacrylate, propane-2,2-diyl bis[(2,6-dibromo-4,1-phenylene)oxy(2-{[3,3,3-tris(4-chlorophenyl)propanoyl]oxy}propane-3,1-diypoxyethane-2,1-diyl]diacrylate, bisphenol A diacrylate, bisphenol A dimethacrylate, tetrabromobisphenol A diacrylate, tetrabromobisphenol A dimethacrylate, and also their ethoxylated analogue compounds, ethanediol diacrylate, butanediol diacrylate, hexanediol diacrylate, diethylene glycol diacrylate, triethylene glycol diacrylate, and N-carbazolyl acrylates, to name only a selection of acrylates and methacrylates that can be used.

In the protective layer there is preferably ≧0 wt. % and ≦10 wt. % of the radiation-curing resin IV), included, more particularly 0.01 to 10 wt. %, more preferably ≧3 wt. % and ≦10 wt. %.

The mixture may further be used with one or more reactive diluents. Reactive diluents which may be included in this use are compounds which in the course of the UV curing likewise (co)polymerize and are therefore incorporated into the polymer network, and are inert towards NCO groups. Such reactive diluents are described exemplarily in P. K. T. Oldring (Ed.), Chemistry & Technology of UV & EB Formulations For Coatings, Inks & Paints, Vol. 2, 1991, SITA Technology, London, pp. 237-285.

They may be esters of acrylic acid or methacrylic acid, preferably of acrylic acid, with mono- or polyfunctional alcohols. Examples of suitable alcohols include the isomeric butanols, pentanols, hexanols, heptanols, octanols, nonanols and decanols, and also cycloaliphatic alcohols such as isobornol, cyclohexanol and alkylated cyclohexanols, dicyclopentanol, arylaliphatic alcohols such as phenoxyethanol and nonylphenylethanol, and also tetrahydrofurfuryl alcohols. Alkoxylated derivatives of these alcohols may also he used. Suitable dihydric alcohols are, for example, alcohols such as ethylene glycol, 1,2-propanediol, 1,3-propanediol, diethylene glycol, dipropylene glycol, the isomeric butanediols, neopentyl glycol, 1,6-hexanediol, 2-ethylhexanediol and tripropylene glycol, or else akoxylated derivatives of these alcohols. Preferred dihydric alcohols are 1,6-hexanediol, dipropylene glycol and tripropylene glycol. Suitable trihydric alcohols are glycerol or trimethylolpropane or their alkoxylated derivatives. Tetrahydric alcohols are pentaerythritol or its alkoxylated derivatives. One suitable hexahydric alcohol is dipentaerythritol or its alkoxylated derivatives. Particularly preferred are the alkoxylated derivatives of the stated tri- to hexahydric alcohols.

In addition, the mixture for producing the protective layer may comprise further additives, which are also used additionally according to mode of application: flow control assistants, such as polyacrylates, silicones, hybrid materials, antistatic agents, solvents, filler agents such as sodium carbonate and/or calcium carbonate, antiblocking agents such as silica, light stabilizers, more particularly UV absorbers, HALS amines, phosphonates, pigments and/or dyes.

The reactive diluents used and also the compounds employed in the radiation-curing resin IV) preferably have, independently of one another, a weight-average molecular weight of ≦800 g/mol, more preferably of ≦500 g/mol and very preferably of ≦300 g/mol. Preferred ranges are 72 to 800 g/mol, preferably from 72 g/mol to 500 g/mol, more preferably 85 g/mol to 300 g/mol. The radiation-curing resin IV) preferably possesses a weight-average molecular weight of at least 72 g/mol, acrylic acid is an example. The reaction diluent used preferably possesses a molecular mass of at least 62 g/mol; an example is ethylene glycol,

In the sum total of resin IV) and reactive diluents in the protective layer, there is preferably ≧0 wt. % and ≦10 wt. % of both components present, more particularly 0.01 to 10 wt. %, with particular preference ≧3 wt. % and ≦10 wt. %.

The Production of the Inventive Layered Construction

The invention further provides a method for producing a layered construction of the invention, in which a mixture at least comprising the radiation-curing resin I), the polyfunctional radiation-curing resin II), the photoinitiator system III) and, optionally, the radiation-curing resin lV) is applied to the photoexposed photopolymer layer and cured, where in the radiation-curing resin I) there are ≦5 wt. % of compounds having a weight-average molecular weight <500 and ≧75 wt. % of compounds having a weight-average molecular weight >1000, the polyfunctional radiation-curing resin II) comprising or consisting of at least one acrylate having at least two radiation-curing groups, and in the mixture there are at least 55 wt. % of the radiation-curing resin I) and not more than 35 wt % of the polyfunctional radiation-curing resin II).

The mixture is applied usefully by means of customary application techniques for liquids to the photopolymer layer comprising one or more holograms. Customary processes are two-dimensionally, continuous applying techniques such as the coating bar methods known to the skilled person (such as doctor blade, knife-over-roll coater, comma bar, floating knife coater, rubber blanket coater, etc.), die systems (e.g. slot die), curtain coaters, roll application processes (patterned rollers, reverse roll coaters), dipping methods, screen printing or screen application.

Where the protective layer is used as a direct seal for the photopolymer layer, application is followed by UV radiation curing. This is done using high-pressure vapour lamps, which can be adapted with different metallic lamp dopants in order to adapt their emission spectra to the photoinitiator system III) that is used. It may be advantageous here to keep the thermal radiation of the high-pressure vapour UV lamps away from the radiation-curing layer by means of dichroic reflectors or the like.

According to a further preferred embodiment of the invention, a procedure may be used in which first of all the mixture of the invention is applied to a smooth substrate surface and then the photopolymer layer, for example a bleached photopolyruer or a photopolymer layer comprising a transmission hologram or reflection hologram, is placed on to the still-liquid varnish, and subsequently pressed on by application of pressure, to produce a laminate. Pressing may be done, for example, using a manual rubber roller and/or a roll laminator, This is followed by curing of the varnish, by means of UV radiation, for example. After curing, the varnish is firmly joined with the photopolymer or hologram and can be parted from the substrate readily and without destruction. As a result of the smoothness of the substrate base, which in this case acts like a transfer base, a varnish layer is obtained which is virtually free from surface defects. The surface quality of the transfer base is replicated in the varnish surface exposed following removal of the varnished photopolymer layer. A suitable transfer base is, generally, any smooth surface, such as, for example, glass, varnished paper, other smooth polymeric films, or metal surfaces. A particularly suitable smooth substrate surface is a glass surface, since glass on the one hand has the requisite smooth surface and is also sufficiently transparent for radiation to cure the mixture, such as UV radiation, for example. Hence even a photopolymer layer of low UV transparency can be laminated, with the step of photoexposing the mixture of the invention taking place through the glass substrate, in other words from the opposite flat side of the photopolymer layer. Accordingly, one particularly preferred method includes the steps of applying the mixture to a transfer surface, preferably an optically transparent transfer surface, more preferably to a glass surface, applying the photopolymer layer to the as yet uncured mixture and pressing it on, with the curing being accompanied by formation of the protective layer in particular by means of radiation curing through the photopolymer layer and/or the transfer surface, preferably through the transfer surface, and subsequently removing from the transfer surface a laminate composed of the protective layer and the photopolymer layer.

Likewise, of course, it is possible to apply the varnish of the invention quickly and efficiently in a roll process. In this case, preferably,
1. the hologram-containing photopolymer film is transported in a roll-to-roll process;
2. the varnish is applied thereto by means of a coating bar, a die system, a curtain coater, a roll application system, a dipping process, screen printing or screen application;
3. the coated film is passed through beneath a transparent or non-transparent roll, at a defined distance smaller than the wet film thickness, and is subjected simultaneously to UV light curing.

Where transparent rolls (made of glass or plastic, for example) are used, the radiation source can be positioned to cure the varnish into the roll. In the case of a non-transparent roll (made of metal, for example), curing always takes place from the photopolymer side.

The rolls may be patterned, so that a specific surface structure remains on the varnish. The patterning may be engraved, or may have a special surface with a low surface tension (e.g. silicone, Teflon). This may be advantageous if the desire is to achieve specific adhesion properties with respect to subsequently applied or laminated layers. It is likewise possible thereby to construct specific optical properties, such as matting, surface scattering, an antireflection layer, an optical spacer or the like.

Products of this kind are of advantage especially for projection screens, for special-purpose optical films for electronic displays, for imaging 3D holograms for point-of-sale or advertising use, for protection from light in outdoor applications, for solar cells, for OLED laminates, and also, generally, for optical elements.

The mixture of the invention for producing the protective layer also possesses adhesive properties, and may therefore be used as a radiation-curable adhesive. Accordingly, with the aid of the mixture, the photopolymer layer can be bonded to a liner. According to a further embodiment of the method of the invention, the mixture, before being cured, is lined with a liner layer and then cured, with the curing taking place in particular by means of radiation curing through the photopolymer layer and/or the liner layer.

The present invention further provides fix the use of the layered construction of the invention in a label, in a security card, in a banknote, in a printed article, in an optical construction, in an electronic display or in another article with multi-layer construction and a holographic optical layer, preferably comprising at least one hologram which has been photoexposed in the photopolymer layer.

In the stated applications, particularly in the case of labels, stickers, optical constructions, and imaging holography (3D pictures and posters), a (pressure-sensitive) adhesive is often used to bond the holograms. Customary pressure-sensitive adhesives are polyacrylate adhesives, which in the case of the existing layered constructions may result in a severe shift in colour in the hologram or a severe shift in the viewing angle, as a result of swelling or contraction of the holographic gratings. The layered construction of the invention can be used to prevent this adverse effect of the (pressure-sensitive) adhesive on the hologram, by positioning of the protective layer between hologram-containing photopolymer layer and the (pressure-sensitive) adhesive layer. The application of the (pressure-sensitive) adhesive in this case takes place by means of liquid application methods or by means of an adhesive layer transfer method on to the protective layer. The protective layer may also be applied directly to the (pressure-sensitive) adhesive layer, present on a transfer film, after which the hologram-containing photopolymer layer is laminated out by means of pressure, and then cured using UV radiation.

The adhesive layer transfer method is also especially suitable if no liquid chemicals are to be used when producing the labels or stickers, or if the thickness of the (pressure-sensitive) adhesive layer is to be set precisely. In that case, in a preceding step, the (pressure-sensitive) adhesive layer is applied to a redetachable substrate and optionally protected with a further detachable laminating sheet. In the adhesive layer transfer method, the laminating sheet is then removed and the (pressure-sensitive) adhesive is laminated directly on to the cured protective layer. The substrate of the (pressure-sensitive) adhesive is usually left as a transfer substrate until the application of the labels/the sticker. The laminating sheet can be omitted if the reverse of the transfer substrate has been made likewise non-adhesive.

Depending on the type of adhesive, it may be advantageous to carry out the UV radiation curing of the protective layer before or after the application of the (pressure-sensitive) adhesive, in which case it is generally preferred to carry out curing before the (pressure-sensitive) adhesive is applied. Likewise preferred is application by means of a film of transfer adhesive.

For the use of a multi-layer construction composed of photopolymer layer and protective layer, and further layers, in a label, in a security card, in a banknote, in a printed article, in an optical construction, in an electronic display, etc., it may be advantageous to use the protective layer directly as an adhesive bonding solution for the photopolymer layer. This is especially true of substrates made of paper, thermoplastics, thermosets, metals, glass, wood, painted, coated, laminated or printed substrates, etc. It may be of advantage here for the substrates to be pretreated. Examples thereof are chemical pretreatment with solvents, for preliminary cleaning such as degreasing, physical pretreatment such as plasma treatment or corona treatment, radiation activation, deposition or application of adhesion-promoting layers. The UV radiation curing of the protective layer in this case is carried out following the application to such substrates. Application is made either by wet application of the protective layer formulation to the photopolymer with subsequent direct lamination of the substrate, or by wet application of the protective layer formulation to the substrate and subsequent direct lamination of the photopolymer, or by simultaneous application, in a laminator, for example. In the case of thick layers which are therefore not UV-transparent or even are non-transparent to UV, it may be advantageous to use other high-energy radiation such as electron beams or X-rays to cure the protective layer. The photoinitiator system III) is usefully tuned to the particular type of radiation used.

In a further preferred embodiment of the invention, a hologram may have been photoexposed into the photopolymer layer. The holograms may be any holographic volume holograms recorded by methods known to the skilled person. These include, among others, multi-colour or full-colour reflection holograms which have been photoexposed monochromatically or generated with two or more lasers of different emission wavelengths, in-line (Gabor) holograms, off-axis holograms, full-aperture transfer holograms, white-light transmission holograms (“rainbow holograms”), Lippmann holograms, Denisyuk holograms, off-axis reflection holograms, edge-lit holograms, and also holographic stereograms.

Possible optical functions of the holograms correspond to the optical functions of light elements such as lenses, mirrors, deflecting mirrors, filters, diffuser lenses (with and without restricted sight zone (eye box)), diffraction elements, light guides, waveguides, projection lenses, masks, optical prisms for spectral chromatic splitting, light directing and light guiding, and also light shaping. These optical elements often exhibit frequency selectivity, according to how the holograms have been photoexposed and the dimensions of the hologram.

Moreover, by means of the layered constructions of the invention, it is also possible to produce holographic images or representations, as for example for personal portraits, biometric representations in security documents, or, generally, images or image structures for advertising, security labels, brand protection, product branding, labels, design elements, decorations, illustrations, collectable cards, pictures and the like, and also images which may represent digital data, etc. both alone and in combination with the products set out above. Holographic images may give the impression of a three-dimensional picture, or else may represent image sequences, short films or a number of different objects, depending on the angle from which, the light source with which (including moving light sources), etc., they are illuminated. On the basis of these diverse design possibilities, holograms, especially volume holograms, constitute an attractive technical solution for the abovernentioned application.

The protective layer of the invention may also be coloured for further design, more particularly using a fluorescent marker, for example. In that case the excitation is in the UV range and the emission is in the visible spectral range. Alternatively or additionally, forensic features may also be accommodated within the protective layer.

### EXAMPLES

The invention is elucidated in more detail below with reference to examples and to FIGS. 1 to 4. In the figures

FIG. 1 shows the schematic construction of a film coating line for producing a photopolymer layer,

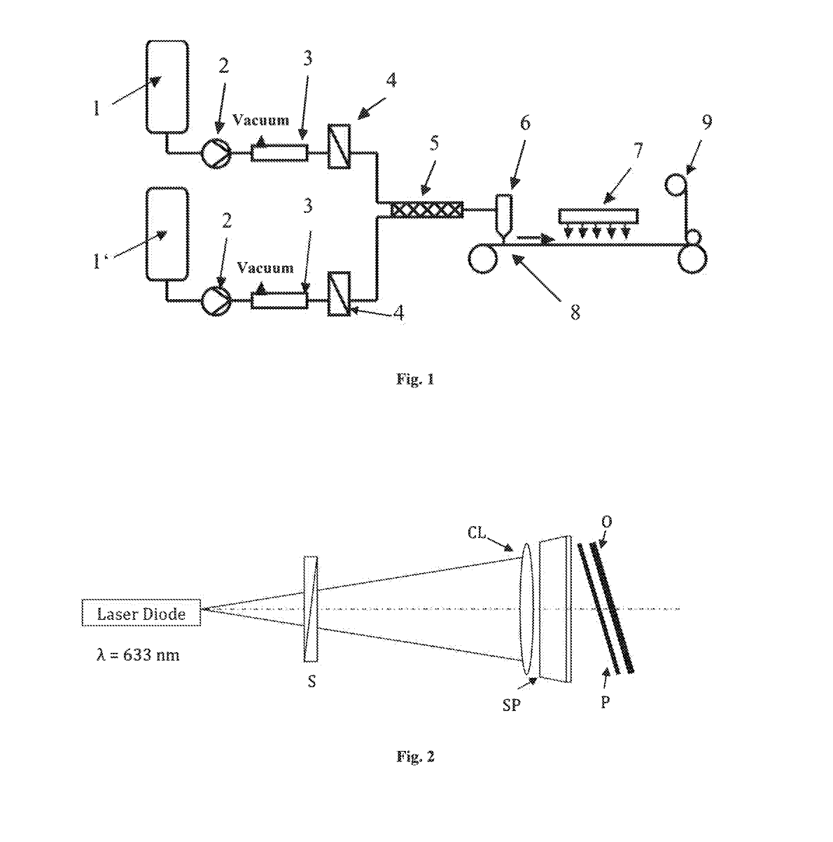

FIG. 2 shows an apparatus for generating a hologram in the photopolymer layer,

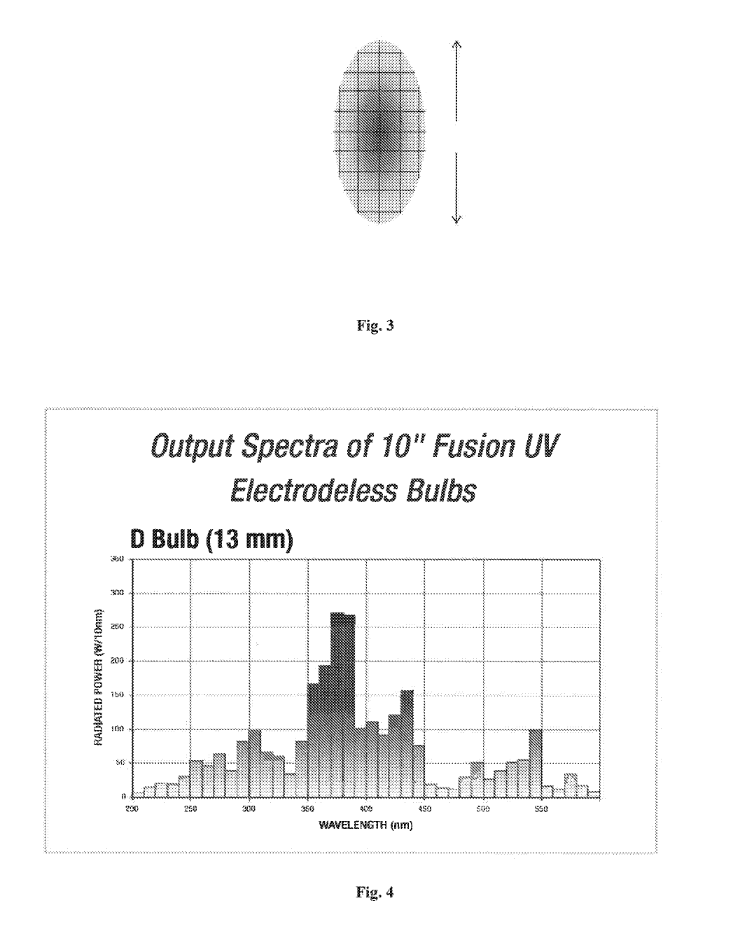

FIG. 3 shows the form of a hologram written using an apparatus according to FIG. 2, and

FIG. 4 shows the spectrum of a UV lamp used for fading (information from manufacturer).

### MATERIALS USED

Materials Used for the Photopolymer Layers:

### Component A

Experimental product from Bayer MaterialScience AG, Leverkusen, Germany, preparation is described below.

### Component B1 (Phosphorothioyitris(oxy-4,1-phenyleniminocarbonyloxyethane-2,1-diyl)triacrylate)

Experimental product from Bayer MaterialScience AG, Leverkusen, Germany, preparation is described below,

### Component B2 (2-({[3-(Methylsulphanyl)phenyl]carbamoyl}oxy)ethyl prop-2-enoate)

Experimental product from Bayer MaterialScience AG, Leverkusen, Germany, preparation is described below.

### Component C (Bis(2,2,3,3,4,4,5,5,6,6,7,7-dodecafluoroheptyl) (2,2,4-trimethylhexane-1,6-diyl)biscarbamate)

Experimental product from Bayer MaterialScierice AG, Leverkusen, Germany, preparation is described below.

### Component D

Fascat 4102 0.07%, urethanization catalyst, butyltin tris(2-ethylhexanoate), product of Arkema GmbH, Dusseldorf, Germany.

BYK®310:

Silicone-based surface additive from BYK-Chemie GmbH, Wesel, 25% strength solution in xylene

### Component E

C.I. Basic Blue 3 (converted to bis(2-ethylhexyl)sulphosuccinate salt) 0.26%, Safranin O (converted to bis(2-ethylhexyl)sulphosuccinate salt) 0.13% and Astrazon Orange G (converted to bis(2-ethylhexyl)sulphosuccinate salt) 0.13% with CGI 909, experimental product from BASF SE, Basel, Switzerland, 1.5%, as solution in 5.8% of ethyl acetate. Percentages are based on the overall formulation of the medium.

### Component F

Ethyl acetate (CAS No. 141-78-6).

### Component G

Desmodur® N 3900, commercial product of Bayer MaterialScience AG, Leverkusen, Germany, hexane diisocyanate-based polyisocyanate, iminooxadiazinedione fraction at least 30%, NCO content: 23.5%.

Carrier Substrate:

Makrofol® DE 1-1 C 125 μm, polycarbonate film in 125 μm thickness, commercial product of Bayer MaterialScience AG, Leverkusen, Germany.

Materials Used for the Resins:

Resin 1: Desmolux U 100 is a commercial product of Bayer MaterialScience AG, Leverkusen, a hard yet flexible aliphatic urethane acrylate in 100% as-supplied form, with a typical viscosity of 7500 mPas/23° C. (as example of resin I, weight fraction Mw<500 g/mol: 1.9%; weight fraction Mw>1000 g/mol: 79.0%).

Resin 2: Tris[2-(acryloyloxy)ethyl]isocyanurate (CAS No. 40220-08-4) was obtained from Sigma-Aldrich GmbH, Steinheirn, Germany (as example of resin II).

Resin 3: Trimethylolpropane triacrylate (CAS No. 15625-89-5) was obtained from ABCR GmbH & Co. KG, Karlsruhe, Germany (as example of resin II).

Resin 4: Di(trimethylolpropane) tetraacrylate (CAS No. 94108-97-1) was obtained from Sigma-Aldrich GmbH, Steinheim, Germany (as example of resin II).

Resin 5: Pentaerythritol triacrylate (CAS No. 3524-68-3) was obtained from Sigma-Aldrich GmbH, Steinheim, Germany (as example of resin II).

Resin 6: Glycerol propoxylate (1PO/OH ) triacrylate (CAS No. 52408-84-1) was obtained from Sigma-Aldrich GmbH, Steinheim, Germany (as example of resin II).

Resin 7: Isobornyl methacrylate (CAS No. 7534-94-3) was obtained under the trade name Ageflex IBOMA from BASF SE, Basel, Switzerland (as example of resin IV).

Resin 8: Tetrahydrofurfuryl acrylate (CAS No, 2399-48-6) was obtained under the product name Sartomer SR 285 from Aricema France, Colombes, France (as example of resin IV).

Resin 9: Dipentaerythritol hexaacrylate (CAS No. 29570-58-9) was obtained under the trade name Agisyn 2830 from Jobachem GmbH, Dassel, Germany (as example of resin II).

Resin 10: Hexanediol diacrylate was obtained under the trade name Laromer® HDDA from BASF SE, Ludwigshafen, Germany (as example of resin IV).

Darocur 1173 is a product of BASF SE, Basel, Switzerland (as example of photoinitiator system III).

Irgacure 2022 is a product of BASF SE, Ludwigshafen, Germany (as example of photoinitiator system III).

BYK® 310: Silicone-based surface additive from BYK-Chemie GmbH, Wesel, 25% strength solution in xylene.

Measurement Methods:

Gel Permeation Chromatography to Determine the Weight-Average Molecular Weight Fractions (GPC)

The eluent used was unstabilized tetrahydrofuran, at a flow rate of 0.6 ml/min. The stationary phase used comprised four serially connected columns from Macherey & Nagel, type: 2× Nucleogel GPC 100-5 and also 2× Nucleogel GPC 50-5. The separation material is crosslinked polystyrene-divinylbenzene polymer with 5 μm particle size and also 50 or 100 Å pore size, with a column length of 30 cm and also 7.7 mm diameter. Each column had a length of 30 cm and a diameter of 7.7 mm. Calibration took place using polystyrene calibration in the range from 162 to 8400 g/mol. Analysis took place using the PSS WINGPC Unity software from PolymerStandardServices.

Measurement of the Photopolyiner Dry Film Thickness

The physical layer thickness was determined using commercial white-light interferometers, such as the FTM-Lite NIR layer thickness measuring instrument from Ingenieursbüro Fuchs.

The layer thickness was determined in principle on the basis of interference phenomena at thin layers. Light waves reflected from two interfaces with different optical densities were superimposed on one another. The undistorted superimposition of the reflected component beams then led to periodic brightening and extinction in the spectrum of a white continuum emitter (e.g, halogen lamp). This superimposition is called interference by the skilled person. The interference spectra were measured and evaluated mathematically.

Solids Content

About 1 g of the sample was applied in an uncoated can lid and spread out effectively by means of a paper clip. Can lid and paper clip had been weighed beforehand. The sample together with paper clip and can lid was dried in an oven at 125° C. for one hour. The solids content was calculated as follows: (final tare mass)*100/(initial tare mass).

Viscosity

The reported viscosities were determined in accordance with DIN EN ISO 3219/A.3 at 23° C. with a shear rate of 40 s⁻¹.

Isocyanate Content (NCO Content)

The reported NCO values (isocyanate contents) were determined in accordance with DIN EN ISO 11909.

Water Content

The reported water contents (KF) from solution were determined in accordance with DIN 51777.

Preparation Protocols for Further Materials Rased for the Holographic Media:

### Preparation of Component A

A 1 L flask was charged with 0.18 g of tin octoate, 374.8 g of ε-caprolactone and 374.8 g of a difunctional polytetrahydrofuran polyether polyol (equivalent weight 500 g/mole OH) and this initial charge was heated to 120° C. and maintained at that temperature until the solids content (fraction of the non-volatile constituents) was 99.5 wt. % or above. The product was then cooled, being obtained in the form of a waxlike solid.

### Preparation of Component B1 (phosphorothioyltris(oxy-4,1-phenylen iminocarbonyloxyethane-2,1-diyl)triacrylate)

A 500 mL round-bottomed flask was charged with 0,1 g of 2,6-di-tert-butyl-4-methylphenol, 0.05 g of dibutyltin dilaurate (Desmorapid® Z, Bayer MaterialScience AG, Leverkusen, Germany) and with 213.07 g of a 27% strength solution of tris(p-isocyanatophenyl) thiophosphate in ethyl acetate (Desmodur® RFE, product of Bayer MaterialScience AG, Leverkusen, Germany) and this initial charge was heated to 60° C., Then 42.37 g of 2-hydroxyethyl acrylate were added dropwise and the mixture was held further at 60° C. until the isocyanate content had dropped below 0.1%. Thereafter the mixture was cooled and the ethyl acetate was removed completely under reduced pressure. The product was obtained as a semicrystalline solid.

### Preparation of Component B2 (2-({[3-(methylsulphanyl)phenyl]carbamoyl}oxy)ethyl prop-2-enoate)

A 100 mL round-bottomed flask was charged with 0.02 g of 2,6-di-tert-butyl-4-methylphenol, 0.01 g of Desmorapid® Z, 11.7 g of 3-(methylthio)phenyl isocyanate and introduced and this initial charge was heated to 60° C. Then 8.2 g of 2-hydroxyethyl acrylate were added dropwise and the mixture was held further at 60° C. until the isocyanate content had dropped below 0.1%. Thereafter the mixture was cooled. The product was obtained as a pale yellow liquid.

### Preparation of the Additive C (bis(2,2,3,3,445,5,6,6,7,7-dodecafluoroheptyl) (2,2,4-trimethyihexane-1,6-diyl)biscarba.mate)

A 2000 mL round-bottomed flask was charged with 0.02 g of Desmorapid® Z and 3.60 g of 2,4,4-trimethylhexane 1,6-diisocyanate (TMDI) and this initial charge was heated to 70° C. Then 11.39 g of 2,2,3,3,4,4,5,5,6,6,7,7-dodecafluoroheptan-1-ol were added dropwise and the mixture was held further at 70° C. until the isocyanate content had dropped below 0.1%. Thereafter the mixture was cooled. The product was obtained as a colourless oil.

Production of Holographic Media on a Film Coating Line

Described hereinafter is the continuous production of holographic media in the form of films from inventive and non-inventive photopolymer formulations.

Production was can-ied out using the film coating line shown in FIG. 1, with the individual components being assigned the following reference numerals:
1 First reservoir container
1′ Second reservoir container
2 Metering device
3 Vacuum degassing device
4 Filter
5 Static mixer
6 Coating device
7 Forced-air dryer
8 Carrier substrate
9 Cover layer

To produce the photopolymer formulation, 304.3 g of component A in a stirring vessel were admixed in steps with a writing monomer mixture of 138 g of component B1 and 138 g of component B2, with 191 g of additive C, 0.60 g of component D, 2.55 g of BYK® 310 and 101 g of component F, and these components were mixed. Then 66.5 g of component E were added to the mixture in the dark and the composition was mixed to give a clear solution, If necessary, the formulation was heated at 60° C. for a short time in order to bring the ingredients into solution more rapidly.

This mixture was then introduced into the first reservoir container 1 of the coating line. The second reservoir container 1′ was filled with component G (polyisocyanate). Both components were then each conveyed by the metering devices 2 in a ratio of 942.2 (components A to F) to 57.8 (component G) to the vacuum degassing device 3, and degassed. From there, they were then each passed through the filter 4 into the static mixer 5, where the components were mixed to give the photopolymer formulation. The liquid material obtained was then supplied in the dark to the coating device 6.

The coating device 6 in the present case is a slot die, with which the skilled person is familiar. Alternatively, however, it is also possible to employ a coating bar (doctor blade) system. By means of the coating. device 6, the photopolymer formulation was applied at a processing temperature of 20° C. to Makrofol DE 1-1 (125 μm) and dried in a forced-air dryer 7 at a crosslinking temperature of 80° C. for 5.8 minutes. This gave a medium in the form of a film, which was then provided with a polyethylene film liner layer 9, 40 μm thick, and was wound up.

The layer thickness obtained in the film was 18 μm±1 μm.

Production of Reflection Holograms in the Photopolymer:

Using apparatus according to FIG. 2, a hologram was photoexposed into the photopolymer. These holograms were monochromatic holograms with a 633 nm laser wavelength. To produce them, sections of the film were cut off in the dark, the laminating sheet was removed, and the films were laminated bubble-free with the photopolymer side downwards on to a glass sheet 1 mm thick with a size of 50×75 mm. The glass sheets used were of the Corning brand from Schott AG, Mainz, Germany.

The beam of a laser (emission wavelength 633 nm) was expanded to a diameter of around 3-4 cm by means of an optional expansion lens AF and a collimating lens CL, which is positioned after a shutter S. The diameter of the expanded laser beam is determined by the aperture of the opened shutter S. A non-uniform intensity distribution is deliberately ensured in the expanded laser beam. Accordingly, the edge intensity Pₑ is ˜ only half the intensity P_{c} in the centre of the expanded laser beam. This P is understood as power/area.

The expanded laser beam first passes through a glass plate SP set up at an oblique angle to the beam, and acting as shearing plate. On the basis of the upwardly reflected interference pattern generated by the two glass surface reflections of the shearing plate SP, it is possible to ascertain whether the laser is emitting stably in single mode. In that case, dark and light strips are visible on a matte panel placed above the shearing plate SP. Only if emission is in single mode are holographic exposures carried out. In the case of the DPSS laser, the single mode can be achieved by adjustment of the pump flow.

The expanded beam passes through a holographic medium P, which is set up at an oblique angle of approximately 15°. This part forms the reference beam, which is then reflected back into the holographic medium P by the object O arranged parallel to the holographic medium P. This part then forms the signal beam of the Denisyuk arrangement. The object O consists of a metal plate covered with white paper, the paper side facing towards the holographic medium P. On the paper there is a square grid in the form of black lines. The edge length of one square is 0.5 cm. This grid is imaged as well in the hologram during holographic photoexposure of the holographic medium P. The interference of signal beam and reference beam in the holographic medium P generates the hologram in the holographic medium P.

The average exposure dose Eₐᵥₑ is set through the opening time t of the shutter S. For a fixed laser power l, therefore, t represents a parameter which is proportional to Eₐᵥₑ. Given that the intensity distribution of the expanded laser beam is non-uniform (bell-shaped), there is variation in the local dose E for gene ating the hologram in the holographic medium P. Together with the oblique placement of the holographic medium P and of the object O with respect to the optical axis, this results in the written hologram possessing an elliptical form. This is shown in FIG. 3.

Since object O is a diffuse reflector, the hologram is easily reconstructed by illumination a point light source (e.g. pocket lamp or LED lamp).

In the next production step, the samples, with the glass side towards the lamp, are placed on the conveyor belt of a UV source and exposed twice with a belt speed of 2.5 m/min. The UV source used is a fusion UV type “D bulb” No. 558434 KR 85 iron-doped Hg lamp with an overall power density of 80 W/cm². The spectrum of the lamp used is shown in FIG. 4 (information from manufacturer). The parameters correspond to a dose of 2×2.0 J/cm², measured using an ILT 490 Light Bug. By “dose”, generally, is meant in each case the quantity of light actually acting on the photopolymer film.

Production of the Layered Constructions

All of the components of the protective layer were intimately mixed in a Speedmixer for one minute. The flow control additive was added last. After mixing, the mixtures were slightly cloudy. The mixture was subsequently knife coated in a thickness of 12 μm, using a wire doctor, directly on to the exposed photopolymer layer with the test hologram. For direct comparison, only half of the test hologram was covered. The radiation-curing layer was then conveyed at 2.5 m/min on a conveyor belt beneath a UV lamp (fusion UV 558434 KR 85, 80 W/cm²) and in this way was cured. The layered construction was then dry.

The composition of the protective layers of the invention is indicated in the examples below:

### Example 1

85.7 g resin 1, 9.5 g resin 2, 2.9 g DarocuK® 1173, 1.9 g BYK® 310.

### Example 2

66.7 g resin 1, 28.6 g resin 2, 2.9 g Darocur® 1173, 1.9 g BYK® 310.

### Example 3

85.7 g resin 1, 9.5 g resin 3, 2.9 g Darocur® 1173, 1.9 g BYK® 310.

### Example 4

85.7 g resin 1, 9.5 g resin 4, 29 g Darocur® 1173, 1.9 g BYK® 310.

### Example 5

85.7 g resin 1, 9.5 g resin 5, 2.9 g Darocur® 1173, 1.9 g BYK® 310.

### Example 6

85.7 g resin 1, 9.5 g resin 6, 2.9 g Darocur® 1173, 1.9 g BYK® 310.

### Example 7

81.4 g resin 1, 9.0 g resin 2, 4.8 g resin 8, 2.9 g Darocur® 1173, 1.9 g BYK® 310.

### Example 8

77.1 g resin 1, 8.6 g resin 2, 9.5 g resin 7, 2.9 g Darocur® 1173, 1.9 g BYK® 310.

### Example 9

63.3 g resin 1, 27.1 g resin 2, 4.8 g resin 8, 2.9 g Darocur® 1173, 1.9 g BYK® 310.

### Example 10

60.0 g resin 1, 25.7 g resin 2, 9.5 g resin 8, 2.9 g Darocur® 1173, 1.9 g BYK® 310.

### Example 11

60.0 g resin 1, 25,7 g resin 2, 9.5 g resin 7, 2.9 g Darocur® 1173, 1.9 g BYK® 310.

Transfer Method for the Varnish:

A smooth plate of float glass, cleaned beforehand in the laboratory washing machine, is degreased with acetone, then dried and fixed on a clipboard. The glass surface is coated with the desired varnish formulation, using a 12 μm wire doctor. A piece of photopolymer at least the same size as the coated area is then laminated or rolled using a manual roller on to the still-wet surface of the varnish on the glass. In this operation, the photopolymer layer is facing the varnish, and the substrate film is facing the manual roller. The layered construction is then fixed with a little adhesive tape to one side of the glass, in order to prevent the film slipping against the glass, and is pushed with this side forwards through the GSH 380 roll laminator at room temperature. The samples, with the glass side facing the lamp, are then placed on the conveyor belt of a UV source and are exposed twice with a belt speed of 2.5 m/min. The UV source used is the aforementioned fusion UV type “D bulb” No. 558434 KR 85 iron-doped Hg lamp with 80 W/cm² overall power density. The parameters correspond to a dose of 2.0×2.0 J/cm² (measured using an ILT 490 Light Bug). The layered construction was then dry. The varnished sample can then be removed easily from the glass.

Use of the Varnish Formulations as Adhesive:

All of the components of the protective layer were intimately mixed in a Speedmixer for one minute. No flow control additive was added in this case. After mixing, the mixtures were slightly cloudy. The mixture was subsequently applied directly to the exposed photopolymer layer with the test hologram, by knife coating in a thickness of 12 μm, using a wire doctor. For direct comparison, only half of the test hologram was covered. Instead of the direct curing after application of the varnish, a black polycarbonate film of Makrofol DE 1-4 (commercial product of Bayer MaterialScience AG, Leverkusen, Germany) is laminated on to the still-wet surface of the varnish, with the aid of a manual roller. Thereafter the samples, with the transparent side facing the lamp, are placed on to the conveyor belt of a UV source and exposed twice with a belt speed of 2.5 m/min. The UV source used is the aforementioned fusion UV type “D bulb” No, 558434 KR 85 iron-doped Hg lamp with 80 W/cm² overall power density. The parameters correspond to a dose of 2×2.0 J/cm² (measured using an ILT 490 Light Bug). The layered construction was then bonded.

The composition of the adhesive formulations of e invention is indicated in the examples below:

### Example 12

85.7 g resin 1, 9.5 g resin 2, 5.0 g Irgacure® 2022.

### Example 13

66.7 g resin 1, 28.6 g resin 2, 5.0 g Irgacure® 2022.

### Example 14

85.7 g resin 1, 9.5 g resin 3, 5.0 g Irgacure® 2022.

### Example 15

85.7 g resin 1, 9.5 g resin 4, 5.0 g Irgacure® 2022.

### Example 16

85.7 g resin 1, 9.5 g resin 5, 5.0 g Irgacure® 2022.

### Example 17

85.7 g resin 1, 9.5 g resin 6, 5.0 g lrgacure® 2022.

### Example 18

85.7 g resin 1, 9.5 g resin 6, 5.0 g Irgacure® 2022.

### Example 19

81.4 g resin 1, 9.0 g resin 2, 4.8 g resin 8, 5.0 g Irgacure® 2022.

### Example 20

77.1 g resin 1, 8.6 g resin 2, 9.5 g resin 7, 5,0 g Irgacure® 2022.

### Example 21

81.4 g resin 1, 9.0 g resin 2, 4.8 g resin 10, 5.0 g Irgacure® 2022.

### Example 22

63.3 g resin 1, 27.1 g resin 2, 4,8 g resin 8, 5.0 g Irgacure® 2022.

### Example 23

60.0 g resin 1, 25.7 g resin 2, 9.5 g resin 8, 5.0 g Irgacure® 2022.

### Example 24

60.0 g resin 1, 25.7 g resin 2, 9.5 g resin 7, 5.0 g Irgacure® 2022.

Verification of the Colour Shift in the Holograms:

To assess a possible colour shift of the varnishes, the samples produced as described above were bonded with a pressure-sensitive adhesive tape from 3M Deutschland GmbH, Neuss, Germany (product number 8212) against the glossy side (1st side) of a black polycarbonate Makrofol DE 1-4 film (commercial product of Bayer MaterialScience AG, Leverkusen, Germany), and the bonded assembly was stored at RT for 7 days.

The layered constructions in which the resin formulations of the invention were used directly as adhesive were stored just at RT for 7 days prior to testing.

After storage of 7 days at room temperature after the curing of the varnish layer and bonding with the pressure-sensitive adhesive tape, the colour change in the hologram was assessed by the naked eye with appropriate illumination by monochromatic LED (red, green, blue), white-light LED and halogen lamp. In all of the examples stated, there were no colour changes visible to the naked eye. In the case of direct application of the pressure-sensitive adhesive tape, a marked colour shift from red to green is evident. Accordingly, the stated object was achieved through the application of the protective layer.

1.-15. (canceled)

16. A layered construction with a protective layer and a photoexposed photopolymer layer, wherein the protective layer is obtainable by reaction of a mixture comprising at least one radiation-curing resin I), a polyfunctional radiation-curing resin II) and a photoinitiator system III), the radiation-curing resin I) comprising ≦5 wt. % of compounds having a weight-average molecular weight <500 and ≧75 wt. % of compounds having a weight-average molecular weight >1000, the polyfunctional radiation-curing resin II) comprising at least one acrylate having at least two radiation-curing groups, and the mixture comprises at least 55 wt. % of the radiation-curing resin I) and not more than 35 wt. % of the polyfunctional radiation-curing resin II).

17. The layered construction according to claim 16, wherein the photopolymer layer comprises crosslinked matrix polymers A) obtained by reaction of at least one polyisocyanate component a) and an isocyanate-reactive component b), crosslinked writing monomers B), a photoinitiator C) and optionally a catalyst D).

18. The layered construction according to claim 16, wherein the radiation-curing resin I) comprises at least one polyester-, polyether-, polycarbonate and/or polyurethane-containing binder having radically polymerizable groups.

19. The layered construction according to claim 16, wherein the radiation-curing resin I) comprises at least one compound selected from the group consisting of polyether acrylates, polyester acrylates, aliphatic urethane acrylates, aromatic urethane acrylates and epoxy acrylates.

20. The layered construction according to claim 16, wherein the radiation-curing resin I) comprises ≦4 wt. % of compounds having a weight-average molecular weight <500 and ≧77 wt. % of compounds having a weight-average molecular weight >1000.

21. The layered construction according to claim 16, wherein the radiation-curing groups of the polyfunctional radiation-curing resin II) are radically polymerizable groups.

22. The layered construction according to claim 16, wherein the polyfunctional radiation-curing resin II) consists exclusively of compounds having at least two radiation-curing groups.

23. The layered construction according to claim 16, wherein the mixture for producing the protective layer comprises 3 wt. % to 30 wt. % of the polyfunctional radiation-curing resin II).

24. The layered construction according to claim 16, wherein the mixture comprises ≦10 wt. % of a radiation-curing resin IV) selected from one or more radiation-curing compounds having radically polymerizable groups.

25. The layered construction according to claim 24, wherein the one or more radiation-curing compounds in the radiation-curing resin IV) have a weight-average molecular weight of ≦800 g/mol.

26. A method for producing a layered construction according to claim 16, comprising applying a mixture comprising the radiation-curing resin I), the polyfunctional radiation-curing resin II) and the photoinitiator system III) to a photoexposed photopolymer layer and cured the mixture, where the radiation-curing resin I) comprises ≦5 wt. of compounds having a weight-average molecular weight <500 and ≧75 wt. % of compounds having a weight-average molecular weight >1000, the polyfunctional radiation-curing resin II) comprising at least one acrylate having at least two radiation-curing groups, and the mixture comprises at least 55 wt. % of the radiation-curing resin I) and not more than 35 wt. % of the polyfunctional radiation-curing resin II).

27. The method according to claim 26, comprising, prior to the curing, covering the mixture with a cover layer.

28. The method according to claim 26, wherein the mixture is applied to a transfer surface, and the photopolymer layer is applied to the as yet uncured mixture and pressed on, forming a laminate composed of the protective layer and the photopolymer layer, and removing the laminate from the transfer surface.

29. The method according to claim 26, wherein the protective layer is applied in a roll process and is subsequently cured, a smooth or structured surface being produced in the protective layer.

30. A method comprising utilizing the layered construction according to claim 16 in a label, in a security card, in a banknote, in a printed article, in an optical construction, in an electronic display or an article comprising a multi-layer construction and a holographical optical layer.
